(19) United States
(12) Patent Application Publication
(10) Pub. No.: US 2022/0343243 A1
(43) Pub. Date: Oct. 27, 2022

(54) SYSTEMS AND METHODS FOR RESOURCE ALLOCATION IN RIDE-HAILING PLATFORMS

(71) Applicant: Beijing DiDi Infinity Technology and Development Co., Ltd., Beijing (CN)

(72) Inventors: Tao HUANG, SAN JOSE, CA (US); Zhiwei QIN, SAN JOSE, CA (US); Qingyang LI, SUNNYVALE, CA (US)

(21) Appl. No.: 17/238,395

(22) Filed: Apr. 23, 2021

(51) Int. Cl. G06Q 10/06; G06Q 10/02; G06N 3/08

(52) U.S. Cl. CPC G06Q 10/06315; G06Q 10/02; G06N 3/08

(57) ABSTRACT

Method, system, and non-transitory computer-readable storage media for determining optimal resource allocation are described. An example method includes: obtaining historical data comprising a plurality of features of different system configurations, a plurality of resource consumptions of the different system configurations, and a plurality of rewards respectively generated from the different system configurations; training a plurality of neural network (NN)-based encoders respectively corresponding to the different system configurations; encoding, using the plurality of trained NN-based encoders, the plurality of features in the historical data to obtain a plurality of encoded features of the different system configurations; training a multi-armed bandit (MAB) model; and generating, using the trained MAB model, a matrix of predicted rewards, each of the predicted rewards corresponding to an estimated reward generated by allocating an amount of resources to one of the different system configurations.

### TECHNICAL FIELD

The disclosure relates generally to resource allocation in a ride-hailing platform, specifically, real-time resource allocation in a mobility-on-demand (MoD) platform with deep neural network encoding and multi-armed bandit (MAB) learning.

### BACKGROUND

Fast-growing online ride-hailing platforms help customers to hire vehicles for rides or ride-share with vehicle owners. Running such platforms may involve making resource allocation decisions daily, such as allocating drivers to serve pending orders, allocating orders among available drivers, managing supply-demand in different regions, and allocating resources for different projects, etc. For example, in this digital age, the growth of a platform or company has to leverage campaigns and promotions across multiple advertising platforms or channels to get more customers to know the brand, products, services, and development, etc. However, with a limited budget to spend on different platforms or channels, an operation team in charge of an ads campaign can only try a limited number of combinations of platforms and channels. In these cases, the resource allocation decisions may be inaccurate and fail to yield optimal outcomes. On the other hand, ride-hailing platforms have access to performance data (as a result of resource allocation) collected by themselves and/or from the campaign platforms, which contain valuable information for making quantitatively strong decisions in resource allocation.

### SUMMARY

Various embodiments of the specification include, but are not limited to, systems, methods, and non-transitory computer-readable media for resource allocation in ride-hailing platforms.

In some embodiments, a computer-implemented method comprises obtaining, by a computing device, historical data comprising a plurality of features of different system configurations, a plurality of resource consumptions of the different system configurations, and a plurality of rewards respectively generated from the different system configurations; training, by the computing device, a plurality of neural network (NN)-based encoders respectively corresponding to the different system configurations based on the plurality of features and the plurality of rewards; encoding, by the computing device using the plurality of trained NN-based encoders, the plurality of features in the historical data to obtain a plurality of encoded features of the different system configurations; training, by the computing device, a multi-armed bandit (MAB) model based on the plurality of encoded features of the different system configurations, the plurality of resource consumptions in the historical data, and the plurality of rewards; and generating, by the computing device using the trained MAB model, a matrix of predicted rewards, each of the predicted rewards corresponding to an estimated reward generated by allocating an amount of resources to one of the different system configurations.

In some embodiments, the method further comprises receiving, by the computing device, a resource constraint; constructing, by the computing device, an optimization model based on the matrix of predicted rewards, the optimization model configured to maximize a total reward subject at least to the resource constraint; and determining, by the computing device based on the optimization model, an optimal resource allocation among the different system configurations.

In some embodiments, the optimization model comprises an objective that is subjected to one or more constraints; the objective comprises a product of the matrix of the predicted rewards and a decision variable matrix, and determining the optimal resource allocation comprises: determining values of the decision variable matrix that maximize the objective.

In some embodiments, each data entry in the historical data comprises a plurality of features of one system configuration, a resource consumption of the one system configuration, and a reward generated by the one system configuration, and training the plurality of NN-based encoders comprises: for the one system configuration, constructing a deep neural network (DNN) that comprises an encoder and a decoder; representing the plurality of features of the one system configuration as a context vector; feeding the context vector into the encoder to obtain an encoded context vector; feeding the encoded context vector into the decoder to obtain a decoded context vector; determining a loss based on the decoded context vector and a supervision extracted from the each data record; and updating one or more parameters of the DNN based on the loss.

In some embodiments, the supervision extracted from the each data record comprises the context vector, and the loss is determined based on a distance between the decoded context vector and the context vector.

In some embodiments, the supervision extracted from the each data record comprises the reward generated by the one system configuration; the decoded context vector comprises an estimated reward, and the loss is determined based on a distance between the historical reward and the estimated reward.

In some embodiments, the MAB model comprises a multi-armed system with a plurality of arms respectively corresponding to the different system configurations.

In some embodiments, each data entry in the historical data comprises a plurality of features of one system configuration, a resource consumption of the one system configuration, and a reward generated by the one system configuration, and training the MAB model comprises: encoding the plurality of features of the one system configuration using an NN-based encoder corresponding to the one system configuration to obtain a plurality of encoded features of the one system configuration; representing the plurality of encoded features as an encoded context vector; concatenating information of the resource consumption of the one system configuration with the encoded context vector to obtain an input; identifying one of the plurality of arms corresponding to the one system configuration; feeding the input into the identified arm to obtain an estimated reward; and updating one or more parameters of the identified arm based on the estimated reward and the reward generated by the one system configuration.

In some embodiments, the MAB model comprises a plurality of multi-armed bandit systems respectively corresponding to the different system configurations, and each of the plurality of multi-armed bandit systems comprises a plurality of arms respectively corresponding to a plurality of resource allocation ranges.

In some embodiments, each data entry in the historical data comprises a plurality of features of one system configuration, a resource consumption of the one system configuration, and a reward generated by the one system configuration, and training the MAB model comprises: identifying one of the one or more multi-armed bandit systems corresponding to the one system configuration; identifying, from the one or more arms of the identified multi-armed bandit system, one arm that corresponds to a resource allocation range covering the resource consumption of the one system configuration; encoding the plurality of features of the one system configuration using an NN-based encoder corresponding to the one system configuration to obtain a plurality of encoded features of the one system configuration; representing the plurality of encoded features as an encoded context vector; feeding the encoded context vector to the identified arm of the identified multi-armed bandit system to obtain an estimated reward; and updating one or more parameters of the identified arm of the identified multi-armed bandit system based on the estimated reward and the reward generated by the one system configuration.

In some embodiments, a first dimension of the value matrix corresponds to the different system configurations, and a second dimension of the value matrix corresponds to a plurality of resource allocation ranges, wherein each of the plurality resource consumptions in the historical data falls in one of the plurality of resource allocation ranges.

In some embodiments, a system comprises one or more processors and one or more non-transitory computer-readable memories coupled to the one or more processors and configured with instructions executable by the one or more processors to cause the system to perform operations comprising: obtaining historical data comprising a plurality of features of different system configurations, a plurality of resource consumptions of the different system configurations, and a plurality of rewards respectively generated from the different system configurations; training a plurality of neural network (NN)-based encoders respectively corresponding to the different system configurations based on the plurality of features and the plurality of rewards; encoding, using the plurality of trained NN-based encoders, the plurality of features in the historical data to obtain a plurality of encoded features of the different system configurations; training a multi-armed bandit (MAB) model based on the plurality of encoded features of the different system configurations, the plurality of resource consumptions in the historical data, and the plurality of rewards; and generating, using the trained MAB model, a matrix of predicted rewards, each of the predicted rewards corresponding to an estimated reward generated by allocating an amount of resources to one of the different system configurations.

In some embodiments, one or more non-transitory computer-readable storage media stores instructions executable by one or more processors, wherein execution of the instructions causes the one or more processors to perform operations comprising: obtaining historical data comprising a plurality of features of different system configurations, a plurality of resource consumptions of the different system configurations, and a plurality of rewards respectively generated from the different system configurations; training a plurality of neural network (NN)-based encoders respectively corresponding to the different system configurations based on the plurality of features and the plurality of rewards; encoding, using the plurality of trained NN-based encoders, the plurality of features in the historical data to obtain a plurality of encoded features of the different system configurations; training a multi-armed bandit (MAB) model based on the plurality of encoded features of the different system configurations, the plurality of resource consumptions in the historical data, and the plurality of rewards; and generating, using the trained MAB model, a matrix of predicted rewards, each of the predicted rewards corresponding to an estimated reward generated by allocating an amount of resources to one of the different system configurations.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the specification. It is to be understood that the foregoing general description and the following detailed description are exemplary and explanatory only, and are not restrictive of the specification, as claimed.

### BRIEF DESCRIPTION OF THE DRAWINGS

Non-limiting embodiments of the specification may be more readily understood by referring to the accompanying drawings in which:

FIG. 1 illustrates an exemplary system of a ride-hailing platform, in accordance with various embodiments of the disclosure.

FIG. 2 illustrates an exemplary diagram of a resource allocation system built based on deep neural network encoding and multi-armed bandit (MAB) learning, in accordance with various embodiments of the disclosure.

FIG. 3A illustrates an exemplary diagram for training a context encoder using a deep neural network, in accordance with various embodiments.

FIG. 3B illustrates an exemplary diagram of a value matrix, in accordance with various embodiments.

FIG. 3C illustrates an exemplary diagram of a MAB model, in accordance with various embodiments.

FIG. 3D illustrates another exemplary diagram of a MAB model, in accordance with various embodiments.

FIG. 4 illustrates an exemplary method for resource allocation in a ride-hailing platform, in accordance with various embodiments.

FIG. 5 illustrates an exemplary system for resource allocation in a ride-hailing platform, in accordance with various embodiments.

FIG. 6 illustrates a block diagram of an exemplary computer system in which any of the embodiments described herein may be implemented.

### DETAILED DESCRIPTION

Non-limiting embodiments of the present specification will now be described with reference to the drawings. Particular features and aspects of any embodiment disclosed herein may be used and/or combined with particular features and aspects of any other embodiment disclosed herein. Such embodiments are by way of example and are merely illustrative of a small number of embodiments within the scope of the present specification. Various changes and modifications obvious to one skilled in the art to which the present specification pertains are deemed to be within the spirit, scope, and contemplation of the present specification as further defined in the appended claims.

A ride-hailing platform may allow a certain amount of resources or budget to be allocated to different promotional channels to promote its brand, product, and services. Such channels may be external or internal. External channels may include advertisement platforms outside of the ride-hailing platform, such as various search engines, social media, mobile applications, etc. Internal channels may refer to advertising services associated with the ride-hailing platform, such as a website or mobile application of the ride-hailing platform. When using external channels, the algorithms controlling the displays of ads or campaigns to end users are usually completely private to the external channels, and the logic and process detail of the algorithms is a complete “black-box” to the ride-hailing platform. When using internal channels, the ride-hailing platform may have access to its own “white-box” algorithms to learn more detailed metrics about the ads and campaigns. Regardless whether it is a “black-box” or “white-box” algorithm, the ride-hailing platform can at least observe its input (e.g., budget, ads/campaign configuration) and the output (e.g., campaign performances such as click rate, number of downloads, number of registration), which may allow the ride-hailing platform to infer whether the campaign is effective. With “white-box” algorithms, the ride-hailing platform may observe more inputs and thus make more informed inferences. In the following description, “black-box” algorithms, as the worst-case scenario, are used for illustrative purposes to describe how to train a deep neural network-based encoder and a MAB model to determine the optimal resource allocations.

The terms “system configuration,” “channel,” “advertisement channel,” and “promotional channel” are used interchangeably in this disclosure to refer to various configurable promotional systems (e.g., advertisement products or services) or decision-making systems for order dispatching and vehicle repositioning. In this disclosure, configurable promotional systems are used for illustrative purposes. The described embodiments may also applicable to other use cases involving resource allocation among different system configurations.

The configuration of each promotional system may be referred to as a system configuration. For example, each such system may have a plurality of settings/knobs that a user/campaign owner can tune in on his/her end. Example settings/knobs may include: platforms where the campaign is made (such as social media, search engines, websites), specific product/service of a platform, specific groups of end-users (e.g., people tagged as millennial by the platform, or people of a specific occupation), specific bidding/pricing strategies provided by the platform that are configurable by the campaign owner (such as bid cap, lowest cost without a cap, lowest cost with a cap), other parameters that are configurable by the campaign owner, other suitable types of system configurations, or any combination thereof. In some embodiments, the “system configuration” may also refer to an adset (a setting shared by a group of ads) within an ads campaign. For example, an ads campaign may include a plurality of adsets within the campaign. These adsets may inherit some configurations from the campaign they belong to and may overwrite some of the configurations or have different configurations from other adsets. Each of these adsets may be treated as a promotional system and be referred to as a “system configuration.”

With the above denotations, a campaign manager may have a plurality of system configurations and a resource budget cap. The campaign manager needs to decide how to distribute the resource budget to some or all of the system configurations to achieve a maximum reward. In some embodiments, such reward may include one or more objective metrics (e.g., performance measurements), such as the click number within a time window, the number of new customers downloaded its application or signed up within a time window, the number of new customers using the application to book their first trips, other suitable metrics, or any combination thereof. In some embodiments, the resource budget may refer to monetary budget but may include other forms of cost depending on the actual use case.

The ride-hailing platform may collect historical records from previously used system configurations. In some embodiments, each of the historical records may include a line of data corresponding to a system configuration with a time interval (e.g., a day, a week, a month, or an hour). The line of data may include various contexts of a corresponding system configuration (e.g., channel configurations, keyword settings, other suitable settings) within the time interval, time information, spending/cost, reward, other suitable information, or any combination thereof.

In some embodiments, to determine the optimal resource allocation strategy, a context encoder using a deep neural network and a MAB model may be trained based on the historical records associated with previous promotional campaigns from various system configurations. The trained context encoder may be used to embed the features of one system configuration, so that a linear relationship between the embedded features and a reward generated by the system configuration may be learned. The MAB model may be trained based on the context encoder to predict rewards that may be generated by allocating different amount of resources to different system configurations. In some embodiments, the training may include an online training phase and an offline training phase. During the online training phase, the MAB model may be self-trained or self-updated based on freshly collected performance metrics of the system configurations. The online training phase is lightweight and fine-tunes the MAB model. During the offline training phase, the MAB model may be trained based on historical data that are collected for a period of time. The offline training phase may occur at a lower frequency than the online training phase to stabilize the MAB model. This online-offline hybrid training framework provides fast adaptiveness (due to the fast adaptation to new data) and robustness (due to the large amount of historical training data) for seeking optimal resource allocation solutions.

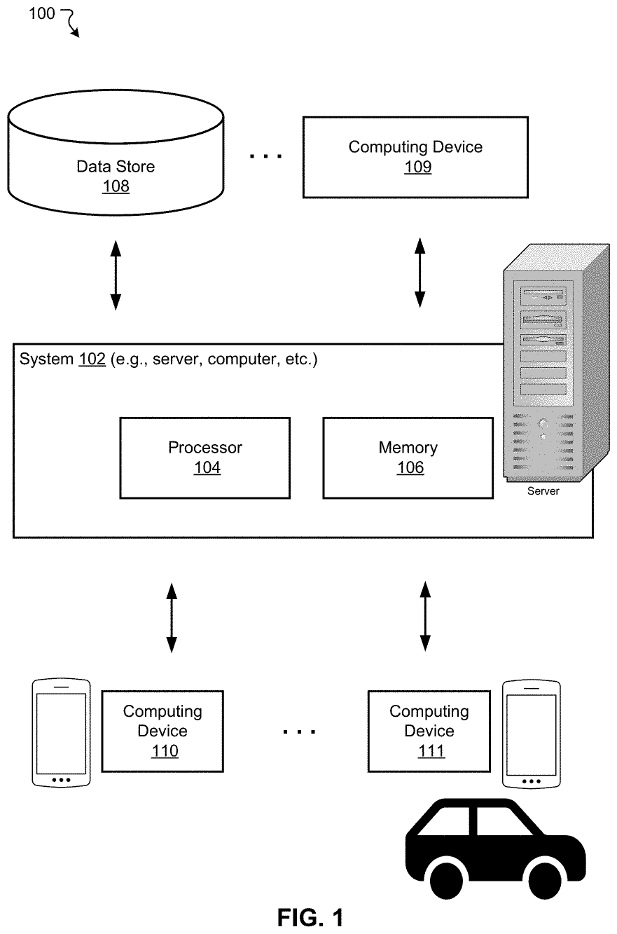

FIG. 1 illustrates an exemplary system 100 for ride order dispatching and vehicle repositioning, in accordance with various embodiments. The operations shown in FIG. 1 and presented below are intended to be illustrative. As shown in FIG. 1, the exemplary system 100 may comprise at least one computing system 102 that includes one or more processors 104 and one or more memories 106. The memory 106 may be non-transitory and computer-readable. The memory 106 may store instructions that, when executed by the one or more processors 104, cause the one or more processors 104 to perform various operations described herein. The computing system 102 may be implemented on or as various devices such as mobile phones, tablets, servers, computers, wearable devices (smartwatches), etc. The computing system 102 above may be installed with appropriate software (e.g., platform program, etc.) and/or hardware (e.g., wires, wireless connections, etc.) to access other devices of the system 100.

The system 100 may include one or more data stores (e.g., a data store 108) and one or more computing devices (e.g., a computing device 109) that are accessible to the computing system 102. In some embodiments, the computing system 102 may be configured to obtain data (e.g., training data such as historical resource allocations and the resulting rewards) from the data store 108 and/or the computing device 109. The computing device 109 may refer to one or more servers providing promotional services or products. The computing device 109 may be third party service providers such as a social media, a search engine, an e-commerce platform. The computing device 109 may also refer to internal advertisement systems or channels (within the ride-hailing platform) such as a mobile application or a website of the ride-hailing platform. The computing system 102 may use the obtained data to train one or more models to determine optimal resource allocations in a ride-hailing platform.

The system 100 may further include one or more computing devices (e.g., computing devices 110 and 111) coupled to the computing system 102. The computing devices 110 and 111 may comprise devices such as cellphones, tablets, in-vehicle computers, wearable devices (smartwatches), etc. associated with users (drivers and/or riders). The computing devices 110 and 111 may transmit or receive data to or from the computing system 102. This way, the computing system 102 may observe the user's response to the promotions directly. The response may be collected and aggregated to generate rewards as part of the historical data.

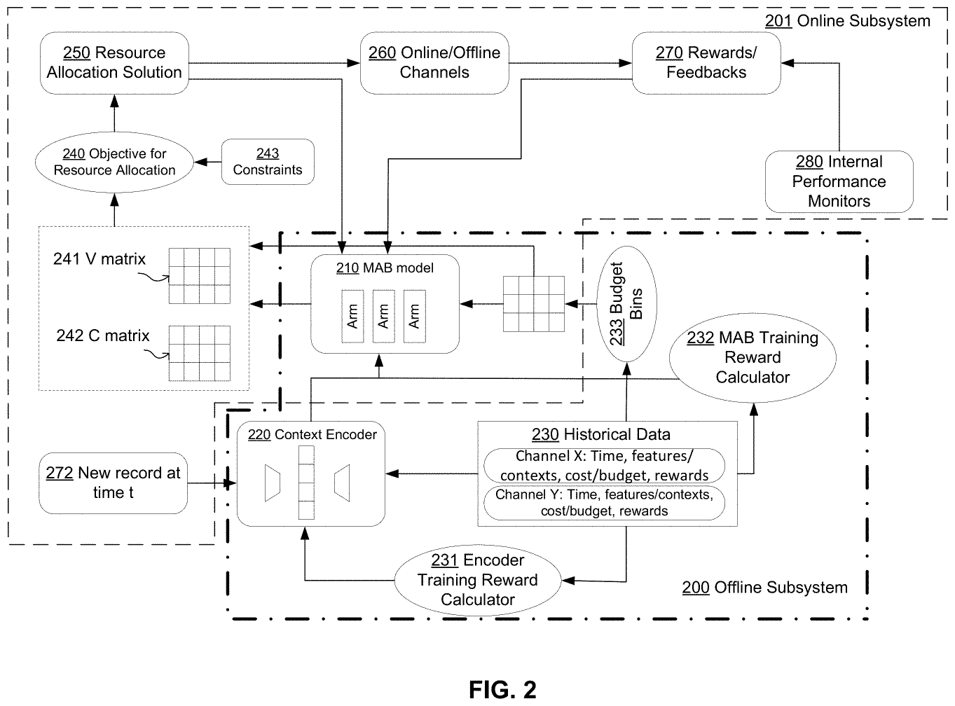

FIG. 2 illustrates an exemplary diagram of a resource allocation system built based on deep neural network encoding and multi-armed bandit (MAB) learning, in accordance with various embodiments of the disclosure. The components in FIG. 2 are for illustrative purposes only. The system may include more, fewer, or alternative components depending on the implementation.

In some embodiments, the resource allocation system in FIG. 2 is configured to obtain a plurality of encoders 220 for a plurality of system configurations. Here, the “obtain” means either training the encoders 220 or obtaining the encoders 220 from another entity that has performed the training. Each encoder 220 may be trained to encode the context (e.g., features) of a corresponding system configuration to obtain encoded contextual features of the system configuration. The resource allocation system may further be configured to determine one or more budget bins 233 for each of the plurality of system configurations. The budget bins 233 may also be referred to as resource allocation ranges. Each of the one or more budget bins 233 indicates an amount range of resources to be allocated to the system configuration. The resource allocation system may further be configured to feed information of the one or more budget bins 233 and the encoded contextual features of the plurality of system configurations into a trained multi-armed bandit (MAB) model 210. The MAB model 210 may be trained to predict a reward generated by one of the plurality of system configurations allocated with an amount of resources. The resource allocation system may further be configured to obtain a plurality of predicted rewards generated by the MAB model 210. Each of the plurality of predicted rewards corresponds to an estimated reward generated by allocating an amount of resources to one of the different system configurations. The resource allocation system may then further be configured to determine, based on the plurality of predicted rewards, an optimal resource allocation solution 250 among the plurality of system configurations that maximizes a total reward.

As shown in FIG. 2, the resource allocation system may include an offline subsystem 200 and an online subsystem 201. In some embodiments, while the offline subsystem 200 is mainly designed for training models and the online subsystem 201 is mainly designed for applying trained models for inferencing, some tasks described herein may be performed in both the offline subsystem 200 and the online subsystem 201. For example, the offline training of the MAB model 210 may be based on historical data 230, and the online training of the MAB model 210 may be based on the observed online data (e.g., extracted from 250 and 270).

In some embodiments, the offline subsystem 200 may be configured to perform various training tasks based on historical data 230. The historical data 230 may include a plurality of features of different system configurations, a plurality of resource consumptions of the different system configurations, and a plurality of rewards respectively generated from the different system configurations. As shown in FIG. 2, the historical data 230 may include a plurality of records collected from the plurality of system configurations, and each record may include a time (a timestamp or a time window), the contextual features of a corresponding system configuration, resources allocated to the corresponding system configuration, or a reward generated by the corresponding system configuration.

The training tasks may include training the plurality of context encoders 220 using a deep neural network based on the plurality of features and the plurality of rewards in the historical data. The trained context encoders 220 may then be used to encode the plurality of features in the historical data to obtain a plurality of encoded features of the different system configurations. Subsequently, the training task may further include training a MAB model 210 based on the plurality of encoded features of the different system configurations, the plurality of resource consumptions in the historical data, and the plurality of rewards in the historical data. In some embodiments, the plurality of context encoders 220 are neural networks respectively corresponding to the plurality of system configurations. That is, each system configuration may have its own context encoder 220 trained based on the historical data 230 collected from the specific system configuration.

For a given system configuration, the underlying relationship between the context (also called features) of the given system configuration and the reward generated by the given system configuration may not be easily learned or represented, e.g., in a linear relationship. In some embodiments, a context encoder 220 may be trained for the given system configuration to encode the context of the given system configuration and generate an encoded feature vector. The goal of training the context encoder 220 is to allow the underlying relationship between the encoded feature vector and the reward to be represented as a linear function.

For example, the training process of the context encoder 220 for a system configuration X may include: for the system configuration, constructing a deep neural network (DNN) that comprises an encoder and a decoder; representing the plurality of features of the system configuration as a context vector; feeding the context vector into the encoder to obtain an encoded context vector; feeding the encoded context vector into the decoder to obtain a decoded context vector; determining a loss based on the decoded context vector and a supervision extracted from the each data record; and updating one or more parameters of the DNN based on the loss. After the training, the encoder portion of the DNN may be used for encoding the context of the system configuration X in the online subsystem 201. In some embodiments, the encoders 220 may also be periodically updated based on newly observed record 272 collected by the online subsystem 201.

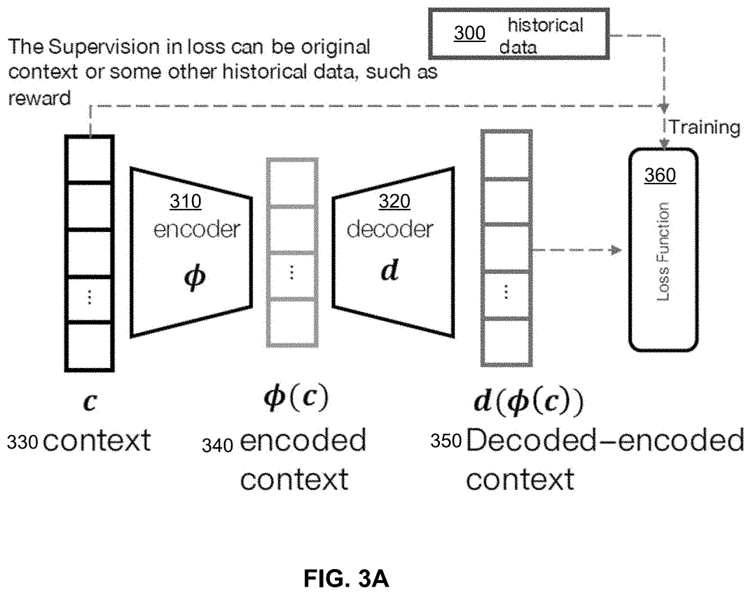

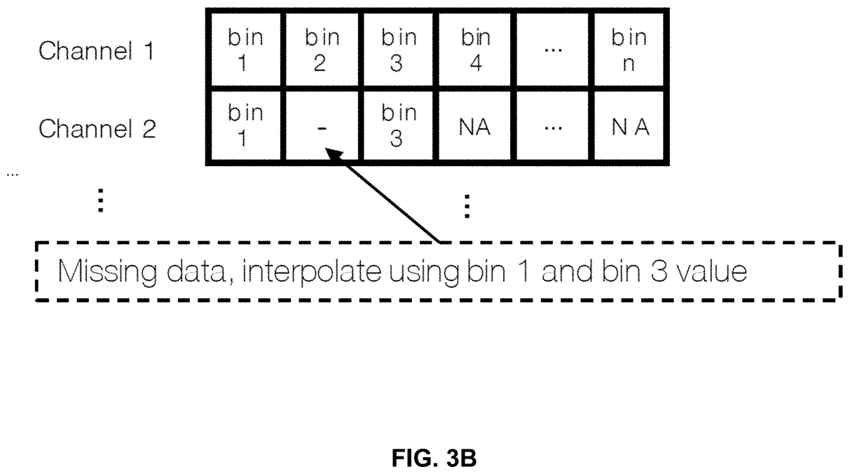

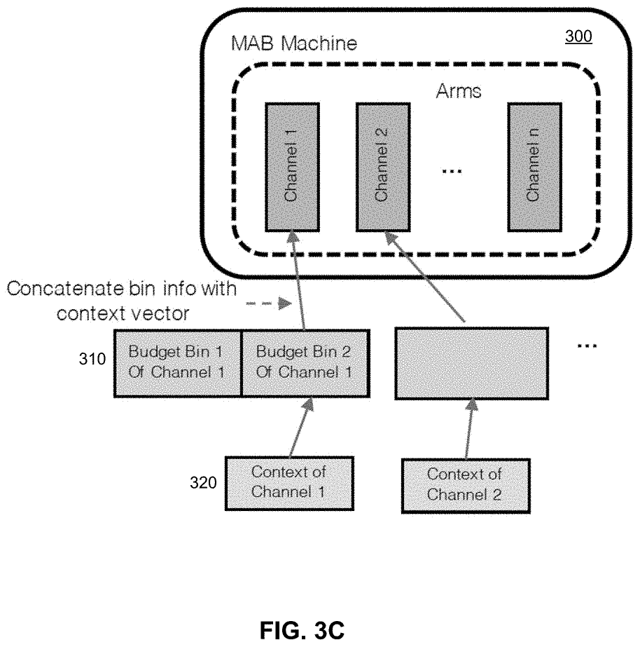

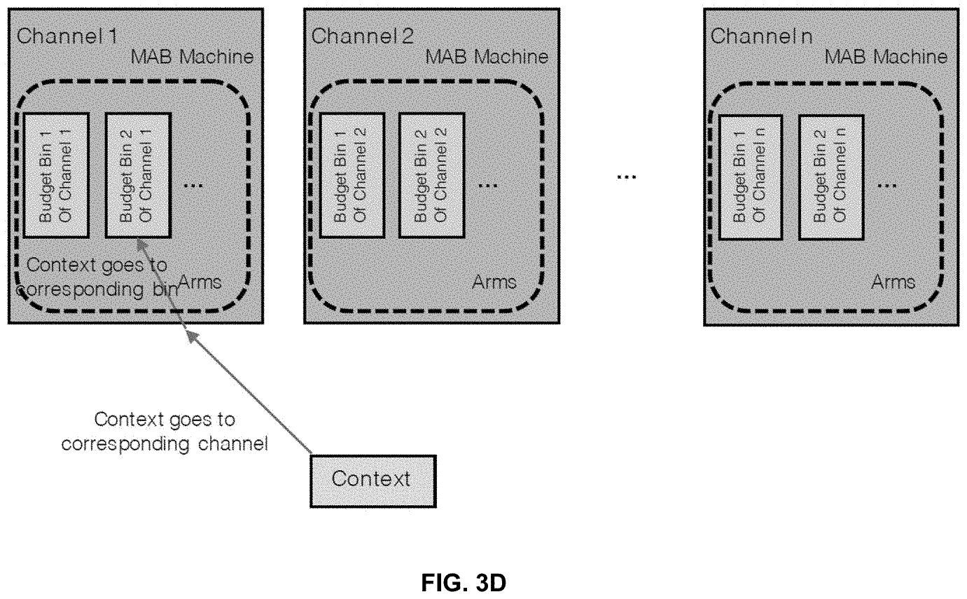

In some embodiments, the above-mentioned “decoded context vector” may refer to an estimated reward, the “supervision” extracted from the historical record may refer to a reward determined by an encoder training reward calculator 231 based on the historical record, and the loss is determined based on a distance between the historical reward and the estimated reward. In other embodiments, the supervision extracted from the each data record comprises the context vector, and the loss is determined based on a distance between the decoded context vector and the context vector. Further details about the training of the encoders 220 may refer to the description of FIG. 3A.

In some embodiments, the offline subsystem 200 may further be configured to discretize the resource budget into a plurality of budget bins 233 (also called resource allocation ranges). This is to facilitate the training of the MAB model 210. MAB training involves a limited set of resources to be allocated between competing (alternative) choices in a way that maximizes their expected gain. The goal of MAB learning is to learn the best strategy to achieve the highest long-term rewards. Thus, MAB learning demands discretized actions. However, the resource budget (e.g., monetary budget) for system configurations is usually continuous. Thus, the resource budget may be discretized into a plurality of budget bins 233 before applying MAB training algorithms to train the MAB model 210. In some embodiments, the MAB model 210 may be trained based on the encoded context/features of a plurality of system configurations (generated by the respective trained context encoder 220), the budget bins 233, and historical rewards determined by an MAB training reward calculator 232 based on the historical data 230. In some embodiments, the MAB training reward calculator 232 and the encoder training reward calculator 231 may be the same. In other embodiments, the MAB training reward calculator 232 and the encoder training reward calculator 231 may be different. For example, different weights may be applied to the historical rewards, fewer or more reward metrics may be considered, or different calculation functions may be applied.

The MAB model 210 may be designed in various ways depending on the implementation. In some embodiments, the MAB model 210 may include one MAB machine with multiple arms, with each arm corresponding to one system configuration. In other embodiments, the MAB model 210 may include a plurality of MAB machines, with each MAB machine corresponding to one system configuration, and each arm within each MAB machine 210 corresponding to one budget bin 233. Further details about the training of the MAB model 210 may refer to the description of FIGS. 3C and 3D.

The trained MAB model 210 may be used to predict rewards for allocating different resources into different system configurations. In some embodiments, the rewards may be represented as a value matrix 241 (denoted as V matrix in FIG. 2). For example, each row of the value matrix 241 corresponds to one system configuration, each column of the value matrix 241 corresponds to one of the budget bins 233, and each value in the value matrix 241 represents a predicted reward by allocating the amount of resource specified by the budget bin 233 to the system configuration. In some embodiments, a cost matrix 242 (denoted as C matrix) may also be constructed in a similar structure as the value matrix 241, and each value in the cost matrix 242 may correspond to a budget bin 233. Since each budget bin 233 is a range, each value in the cost matrix 242 may be a middle point of the range of the corresponding budget bin 233. In some embodiments, other types of data structures may be used to represent the rewards and costs.

In some embodiments, the value matrix 241 and/or the cost matrix 242 may include one or more masks, such as dummy values “N/A.” The masks may be necessary to align the columns and/or rows of the matrix 241 and/or 242, or to mask missing or invalid data. For example, a campaign manager may want to limit the budget of a certain system configuration or a set of system configurations. The limit could either be a lower limit or an upper limit. Any bin that is outside the limit may be masked as “N/A” to indicate invalidity. As another example, a campaign manager may want to limit the ratio of change of one system configuration, or a set of system configurations, or all system configurations between consecutive time intervals. The reason may include risk-averse and to avoid budget allocation from changing drastically in a short period. In this case, assuming the resource allocation solution of the last time interval is denoted as d_{old}(ch), and the change ratio limit is [ρₗ; ρₕ], then any budget bin with budget/cost higher than d_{old}(ch)*ρₕ or lower than d_{old}(ch)*ρₗ may be masked as “N/A.” More details about determining budget bins 233 may refer to the description of FIG. 3B.

The predicted rewards may be used as a basis to determine the optimal resource allocation solution 250 for a given resource constraint (budget). For example, assuming the plurality of rewards are represented as the value matrix 241 and the cost matrix 242, the process of seeking the optimal resource allocation solution 250 may include: constructing an optimization model based on the value matrix 241 and the cost matrix 242, the optimization model configured to maximize a total reward subject at least to the resource constraint; and determining, based on the optimization model, an optimal resource allocation among the different system configurations. The optimization model may comprise an objective 240 that is subjected to one or more constraints 243, including the resource constraint; the objective 240 may comprise a product of the matrix of the predicted rewards and a decision variable matrix, and determining the optimal resource allocation comprises: determining values of the decision variable matrix that maximize the objective 240.

For example, the objective 240 for resource allocation may be constructed as following equations (1)-(4).

$${max}_{y} tr ( {V}^{T} Y ) \qquad ( 1 )$$

$$s . t . tr ( {C}^{T} Y ) \leq D \qquad ( 2 )$$

$$Y {1}_{m} \leq {1}_{n} \qquad ( 3 )$$

$$each element of Y , {y}_{c h , β} ∈ \{ 0 , 1 \} ∀ c h ∈ K , β ∈ B \qquad ( 4 )$$

where K refers to the plurality of system configurations, n refers to the number of the plurality of system configurations, ch refers to one of the plurality of system configurations, B refers to the budget bins 233, β refers to one of the budget bins 233, V^{T} refers to the value matrix 241, C^{T} refers to the cost matrix 242, Y refers to a plurality of decision variables that may be represented in a matrix form, tr(V^{T}Y) refers the sum of the element-wise product of V^{T} and Y, e.g., Σ_{ch∈C} Σ_{β∈B} v(ch, β)y_{ch,β}), 1ₘ means a dimension m vector with m 1s, 1ₙ means a dimension n vector with n 1s, and Y1ₘ means a dimension n vector in which the chₜₕ position is Σ_{β∈B} y_{ch,β}.

The above equation (4) indicates a binary selection, in which y_{ch,β} can only be 0 or 1, no other value is possible. If y_{ch,β} is 1, it means the amount of resource indicated by the βₜₕ budget bin will be allocated to the chₜₕ system configuration. Otherwise, the amount of resource indicated by the βₜₕ budget bin is not allocated to the chₜₕ system configuration.

The above equation (1) includes the objective that needs to be maximized. The V^{T} is pre-calculated value matrix 241, and the Y is the decision variables representing the resource allocation solution 250.

The above equation (2) includes a resource allocation constrain. The total allocated resources cannot exceed the overall resource budget D.

The above equation (3) means: for any system configuration ch, Σ_{β∈B} y_{ch,β}≤1. It means at most one budget bin 233 may be selected for the system configuration. If all budget bins 233 of the system configuration are not selected (y_{ch,β} are all zeros), it means the system configuration is not allocated with any resource.

As described above, the value matrix 241 and/or the cost matrix 242 may include multiple masks. These masks cannot be directly used for calculation and solving the objective 240. In some embodiments, the masks are converted using the “big-M” method to numeric values. For example, any position in the above matrix masked with “NA” means it is not available for selection, therefore, its corresponding solution y should be 0. To achieve this, each “NA” in the cost function 242 may be replaced with a big positive integer value M (e.g., 1,000,000), and each “NA” in the value function 241 may be replaced with a big negative integer value M (e.g., −1,000,000). If the big positive integer value M in the cost matrix is selected, it will make the total cost exceeds D, i.e., breaking the constrain in equation (2), which means the solution is invalid. If the big negative integer value M in the value matrix is selected, it will make the total value negative too and thus not maximized, which means the solution is not optimal and will not be selected.

In some embodiments, the objective for resource allocation 240 defined by equations (1)-(4) may be formed as an integer programming problem, which may be solved by open-source packages such as CVX, Scipy, or commercial software such as CPLEX, GUROBI, MOSEK, MATLAB, FICO Xpress, etc.

After the optimal resource allocation solution 250 is determined, it may be deployed to the system configurations 260. The deployment may include allocating resources to various system configurations 260 according to the optimal resource allocation solution 250. The system configurations 260 may include online channels such as websites, mobile applications, social media, etc., and offline channels such as physical letters, postcards, etc. Rewards and feedbacks 270 may be timely collected from the system configurations 260. The rewards and feedbacks 270 may include metrics (e.g., performance of the system configurations) provided from the platforms hosting the system configurations. Also, the ride-hailing platform may have internal performance monitors 280 that collect more detailed performance metrics. These performance metrics may be used for online training of the context encoders 220 and/or the MAB model 210, and be collected as a historical record for next round of offline training.

FIG. 3A illustrates an exemplary diagram for training a context encoder using a deep neural network, in accordance with various embodiments. The structure and data flow shown in FIG. 3A are intended to be illustrative and may be configured differently depending on the implementation.

The goal of multi-arm bandit learning may include building a linear function between input features and outcomes based on historical data (specifically, based on historical input features and historical outcomes). For resource allocation among system configurations, the input features may refer to the context of a historical record collected from a system configuration. The context may include context/features of the system configuration during a specific time interval. For example, such a linear relationship may be represented as f(c)=θ^{T}c+μ, where θ is the linear function coefficient and c is the context/features represented in a vector format, μ is a scalar offset, and f( ) represents the prediction.

In some embodiments, a linear relationship may exist between the input features and the outcomes. In other embodiments, however, the context might not happen to have such nice property. In this case, a more realistic situation is that the prediction is linear on some nonlinearly mapped/encoded output of the original context. That is, given a raw context c, there might be a mapping/encoder ϕ( ) 310, such that the prediction based on c is linear to ϕ(c), not the original context c.

In some embodiments, one encoder 310 may be trained for each of a plurality of system configurations using a deep neural network (DNN). For example, the training may include: for each of the plurality of system configurations, constructing a DNN that comprises an encoder 310 and a decoder 320; feeding a context vector 330 extracted from each historical record 300 collected from the each system configuration into the encoder 310 to obtain an encoded context vector 340; feeding the encoded context vector 340 into the decoder 320 to obtain a decoded-encoded context vector 350; determining a loss using a loss function 360 based on the decoded-encoded context vector 350 and a supervision extracted from the historical record 330; and updating one or more parameters of the DNN based on the loss.

For example, the DNN may be a multi-layer deep neural network with a front portion as the encoder 310 and the rear portion as the decoder 320. The layers within the encoder 310 and/or the decoder 320 may be fully connected (FC) dense layers, but other types of layers such as an attention layer are also allowed.

In FIG. 3A, the decoded-encoded context 350 generated by the decoder 320 may be treated as an output of the DNN, and the training of the DNN is to make the output close to a supervision extracted from the training data (e.g., the historical record) and penalize dissimilarities between the output and the supervision using the loss function 360. Example loss functions 360 may include a mean squared error (MSE), mean absolute error (MAE), or another suitable type of loss function.

In some embodiments, the supervision extracted from the historical record 330 may include the context vector 330 extracted from the each historical record, and the loss is determined based on a distance between the decoded-encoded context vector 350 and the context vector 330. By doing so, the encoder 310 is trained to keep as much information in the original context as possible, and the decoder 320 may be trained to recover the original context as much as possible.

In some embodiments, the supervision extracted from the historical record 330 may include a historical reward generated by the system configuration being allocated with an amount of resource, the decoded-encoded context vector 350 may include an estimated reward, and the loss is determined based on a distance between the historical reward and the estimated reward. The reward may include a weighted sum of a plurality of objective metrics observed from allocating the amount of resource to the system configuration. One example historical reward may be calculated as:

0.2*adset_click_num−1.0*adset_impression_num+1.5*first_trip+1.5*sign_up_first_trip_in_3d+1.0*sign_up_first_trip_7d

where adset_click_num represents the number of clicks on the adset (e.g., a system configuration), adset_impression_num represents the number of impressions of the adset (e.g., a number of times the ads is displayed), first_trip represents the number of trips from new customers, sign_up_first_trip_in_3d represents the number of first trips within 3 days after signing up, and sign_up_first_trip_7d represents the number of first trips within 7 days after signing up, and the floating numbers represent the weights applied to the above metrics.

In some embodiments, each system configuration may have its own encoder 310 trained. In other embodiments, one encoder 310 may be shared by multiple system configurations. The above training process jointly trains the encoder 310 and the decoder 320. Once the training is finished, the encoder 310 portion may be used to train the MAB model 210 illustrated in FIG. 2.

As mentioned above, besides the trained encoders 310, training the MAB model also requires discretized actions, or arms in MAB learning terminology. In some embodiments, the resource allocation budget (e.g., a continuous monetary budget) may be discretized into budget bins. These budget bins correspond to the arms of the MAB machines. Subsequently, the trained MAB model may predict the value for each combination of one system configuration and one budget bin, which may be used as the basis to solve the optimization problem (e.g., the objective 240) described in FIG. 2.

FIG. 3B illustrates an exemplary diagram of a value matrix, in accordance with various embodiments. In some embodiments, the rows of the value matrix may correspond to a plurality of system configurations, and the columns of one row in the value matrix may correspond to a plurality of budget bins for the system configuration corresponding to the row. Therefore, prior to constructing the value matrix, the budget bins for each system configuration need to be determined first.

In some embodiments, discretizing a resource allocation budget into budget bins for a system configuration may start with determining the budget range from historical data. For example, denoting the budget range for system configuration ch as [L_{ch}, H_{ch}] and the number of budget bins as nb_{ch}, there are various ways to discretize the range [L_{ch}, H_{ch}] into nb_{ch} bins. Subsequently, the budget bins may be determined by discretizing the budget range with various discretization processes.

For example, an arithmetic discretization process may be employed to evenly discretize the range [L_{ch}, H_{ch}] into nb_{ch} bins, increment as Δ_{ch}=(H_{ch}−L_{ch})/nb_{ch}. The budget bins may be represented as [L_{ch}, L_{ch}+Δ_{ch}), [L_{ch}+Δ_{ch}, L_{ch}+2*Δ_{ch}), . . . , [H_{ch}−Δ_{ch}, H_{ch}]. Each bin may be represented by the middle point of its range.

As another example, a geometric discretization process may be employed to unevenly, in a geometric sense, discretize the range [L_{ch}, H_{ch}] into nb_{ch} bins. This process may be proper because the marginal effect of increasing the budget for a system configuration is decreasing as the budget grows. It means, for lower budget ranges, the bins should be denser, and for higher budget ranges, the bins should be sparser. In some embodiments, the increment may be defined as

$${Δ}_{c h} = \frac{{H}_{c h} - {L}_{c h}}{{( 1 + Ratio )}^{n {b}_{c h} - 1}} .$$

Thus, the bins may be represented as [L_{ch}, L_{ch}+Δ_{ch}), [L_{ch}+Δ_{ch}, L_{ch}+Δ_{ch}(1+Ratio)), . . . , [L_{ch}+Δ_{ch}, L_{ch}+Δ_{ch}(1+Ratio)^{nb}^{_{ch}}⁻²], [L_{ch}+Δ_{ch}, L_{ch}+Δ_{ch}(1+Ratio)^{nb}^{_{ch}}⁻³]. In some embodiments, Ratio may refer to a predetermined value configured by campaign managers.

As shown in FIG. 3B, each system configuration may correspond to a list of budget bins, but not all bins in each system configuration are valid. Thus, two system configurations may have different numbers of bins. In order to align the columns and rows of the value matrix in FIG. 3B, in some embodiments, the bins with invalid values may be replaced with dummy masks like a string value “N/A.” In other embodiments, if a bin is in the middle of other bins, its value may be obtained by interpolating its neighboring values. As shown in FIG. 3B, the second bin for channel 2 may be determined by interpolating the values from the first bin and the third bin.

After discretizing the resource budget into a plurality of bins, one or more MAB machines may be constructed and trained using historical data. Depending on the structure of the MAB model, the training process and the application of the trained MAB model may be different. FIGS. 3C and 3D describe two different ways to construct and train the MAB model.

FIG. 3C illustrates an exemplary diagram of a MAB model, in accordance with various embodiments. The structure and data flow shown in FIG. 3C are intended to be illustrative and may be configured differently depending on the implementation.

In some embodiments, one MAB machine 300 may be constructed and trained based on a plurality of historical records collected from a plurality of system configurations. Each of the plurality of historical records may include a plurality of features of one system configuration, a resource consumption of the one system configuration, and a reward generated by the one system configuration. The training of the MAB machine 300 may include: encoding the plurality of features of the one system configuration using an NN-based encoder corresponding to the one system configuration to obtain a plurality of encoded features of the one system configuration; representing the plurality of encoded features as an encoded context vector; concatenating information of the resource consumption of the one system configuration with the encoded context vector to obtain an input; identifying one of the plurality of arms corresponding to the one system configuration; feeding the input into the identified arm to obtain an estimated reward; and updating one or more parameters of the identified arm based on the estimated reward and the reward generated by the one system configuration.

In some embodiments, the MAB machine 300 may include a plurality of arms respectively corresponding to the plurality of system configurations. With this setup, the input to one arm of the MAB machine 300 may include the contextual features of the system configuration 320 corresponding to the arm, as well as the information of the resource budget bin 310. Therefore, during the training of the MAB machine 300 or using the trained MAB machine 300 to predict rewards, the contextual features of the system configuration 320 and the information of a corresponding resource budget bin 310 may be concatenated before being fed into the MAB machine 300.

FIG. 3D illustrates another exemplary diagram of a MAB model, in accordance with various embodiments. The structure and data flow shown in FIG. 3D are intended to be illustrative and may be configured differently depending on the implementation.

Different from the single MAB machine system described in FIG. 3C, in some embodiments, multiple MAB machines may be constructed, with each MAB machine corresponding to one system configuration, and each arm within one MAB machine corresponding to one resource budget bin (resource allocation range).

With this configuration, the training of the multiple MAB machines may include, for the each historical record: identifying one of the one or more multi-armed bandit systems corresponding to the one system configuration; identifying, from the one or more arms of the identified multi-armed bandit system, one arm that corresponds to a resource allocation range covering the resource consumption of the one system configuration; encoding the plurality of features of the one system configuration using an NN-based encoder corresponding to the one system configuration to obtain a plurality of encoded features of the one system configuration; representing the plurality of encoded features as an encoded context vector; feeding the encoded context vector to the identified arm of the identified multi-armed bandit system to obtain an estimated reward; and updating one or more parameters of the identified arm of the identified multi-armed bandit system based on the estimated reward and the reward generated by the one system configuration.

Both the MAB machines described in FIGS. 3C and 3D may be trained with various algorithms, such as Linear Upper Confidence Bound (LinUCB) and Thompson Sampling. These two algorithms are both Bayesian and iterative updating type of algorithms, therefore, they can keep update and evolve themselves based on the observed data from the online system.

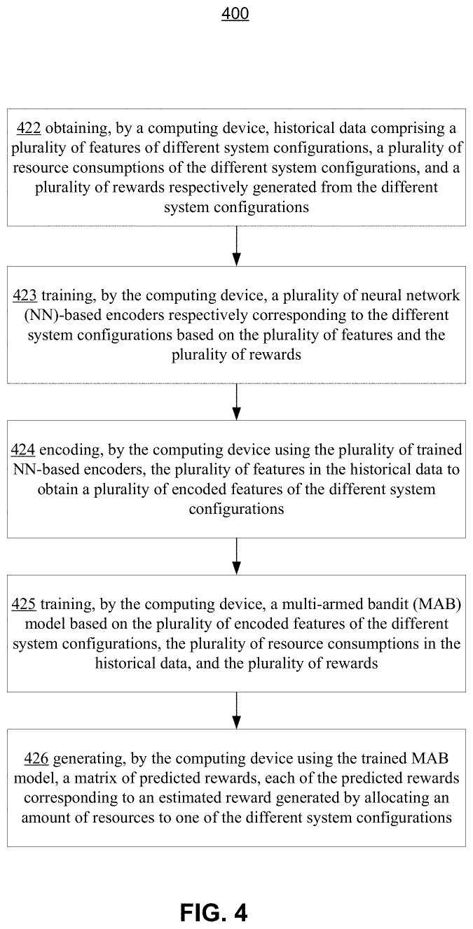

FIG. 4 illustrates an exemplary method 400 for resource allocation in a ride-hailing platform, in accordance with various embodiments. The method 400 may be implemented in various environments including, for example, the environment 100 of FIG. 1. The exemplary method 400 may be implemented by the system 102. The operations of method 400 presented below are intended to be illustrative. Depending on the implementation, the exemplary method 400 may include additional, fewer, or alternative steps performed in various orders or in parallel.

Block 422 includes obtaining, by a computing device, historical data comprising a plurality of features of different system configurations, a plurality of resource consumptions of the different system configurations, and a plurality of rewards respectively generated from the different system configurations.

Block 423 includes training, by the computing device, a plurality of neural network (NN)-based encoders respectively corresponding to the different system configurations based on the plurality of features and the plurality of rewards. In some embodiments, each data entry in the historical data comprises a plurality of features of one system configuration, a resource consumption of the one system configuration, and a reward generated by the one system configuration, and training the plurality of NN-based encoders comprises: for the one system configuration, constructing a deep neural network (DNN) that comprises an encoder and a decoder; representing the plurality of features of the one system configuration as a context vector; feeding the context vector into the encoder to obtain an encoded context vector; feeding the encoded context vector into the decoder to obtain a decoded context vector; determining a loss based on the decoded context vector and a supervision extracted from the each data record; and updating one or more parameters of the DNN based on the loss. In some embodiments, the supervision extracted from the each data record comprises the context vector, and the loss is determined based on a distance between the decoded context vector and the context vector. In some embodiments, the supervision extracted from the each data record comprises the reward generated by the one system configuration; the decoded context vector comprises an estimated reward, and the loss is determined based on a distance between the historical reward and the estimated reward.

Block 424 includes encoding, by the computing device using the plurality of trained NN-based encoders, the plurality of features in the historical data to obtain a plurality of encoded features of the different system configurations.

Block 425 includes training, by the computing device, a multi-armed bandit (MAB) model based on the plurality of encoded features of the different system configurations, the plurality of resource consumptions in the historical data, and the plurality of rewards. In some embodiments, the MAB model comprises a multi-armed system with a plurality of arms respectively corresponding to the different system configurations. In some embodiments, each data entry in the historical data comprises a plurality of features of one system configuration, a resource consumption of the one system configuration, and a reward generated by the one system configuration, and training the MAB model comprises: encoding the plurality of features of the one system configuration using an NN-based encoder corresponding to the one system configuration to obtain a plurality of encoded features of the one system configuration; representing the plurality of encoded features as an encoded context vector; concatenating information of the resource consumption of the one system configuration with the encoded context vector to obtain an input; identifying one of the plurality of arms corresponding to the one system configuration; feeding the input into the identified arm to obtain an estimated reward; and updating one or more parameters of the identified arm based on the estimated reward and the reward generated by the one system configuration.

In some embodiments, the MAB model comprises a plurality of multi-armed bandit systems respectively corresponding to the different system configurations, and each of the plurality of multi-armed bandit systems comprises a plurality of arms respectively corresponding to a plurality of resource allocation ranges. In some embodiments, each data entry in the historical data comprises a plurality of features of one system configuration, a resource consumption of the one system configuration, and a reward generated by the one system configuration, and training the MAB model comprises: identifying one of the one or more multi-armed bandit systems corresponding to the one system configuration; identifying, from the one or more arms of the identified multi-armed bandit system, one arm that corresponds to a resource allocation range covering the resource consumption of the one system configuration; encoding the plurality of features of the one system configuration using an NN-based encoder corresponding to the one system configuration to obtain a plurality of encoded features of the one system configuration; representing the plurality of encoded features as an encoded context vector; feeding the encoded context vector to the identified arm of the identified multi-armed bandit system to obtain an estimated reward; and updating one or more parameters of the identified arm of the identified multi-armed bandit system based on the estimated reward and the reward generated by the one system configuration.

Block 426 includes generating, by the computing device using the trained MAB model, a matrix of predicted rewards, each of the predicted rewards corresponding to an estimated reward generated by allocating an amount of resources to one of the different system configurations. In some embodiments, a first dimension of the value matrix corresponds to the different system configurations, and a second dimension of the value matrix corresponds to a plurality of resource allocation ranges, wherein each of the plurality resource consumptions in the historical data falls in one of the plurality of resource allocation ranges.

In some embodiments, the method 400 may further comprise receiving, by the computing device, a resource constraint; constructing, by the computing device, an optimization model based on the matrix of predicted rewards, the optimization model configured to maximize a total reward subject at least to the resource constraint; and determining, by the computing device based on the optimization model, an optimal resource allocation among the different system configurations. In some embodiments, the optimization model comprises an objective that is subjected to one or more constraints; the objective comprises a product of the matrix of the predicted rewards and a decision variable matrix, and determining the optimal resource allocation comprises: determining values of the decision variable matrix that maximize the objective.

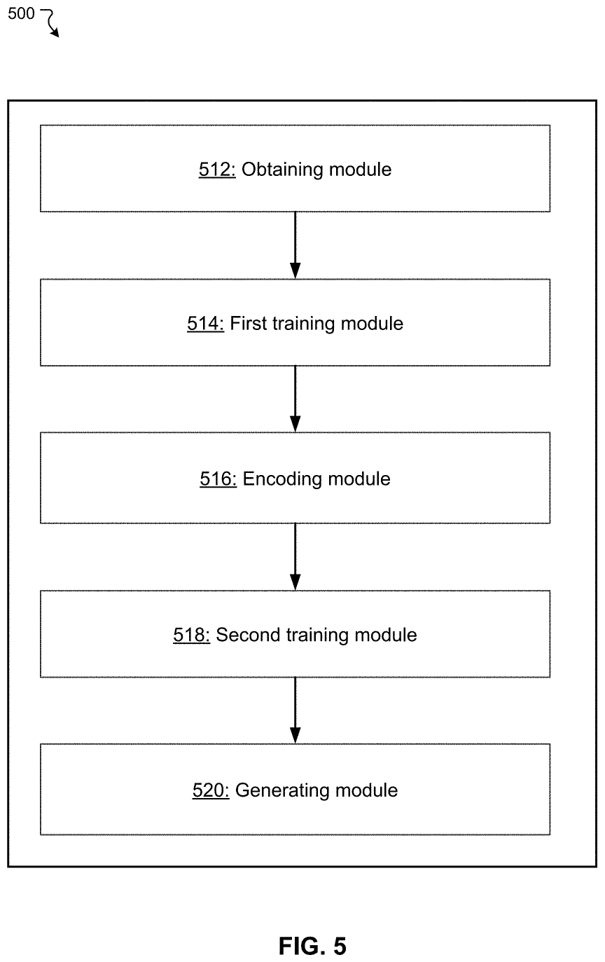

FIG. 5 illustrates a block diagram of a computer system 500 for resource allocation in a ride-hailing platform, in accordance with various embodiments. The computer system 500 may be an exemplary implementation of the resource allocation system of FIG. 2. The method 400 may be implemented by the computer system 500. The computer system 500 may include one or more processors and one or more non-transitory computer-readable storage media (e.g., one or more memories) coupled to the one or more processors and configured with instructions executable by the one or more processors to cause the system or device (e.g., the processor) to perform the method 400. The computer system 500 may include various units/modules corresponding to the instructions (e.g., software instructions).

In some embodiments, the computer system 500 may include an obtaining module 512, a first training module 514, an encoding module 516, a second training module 518, and a generating module 520.

In some embodiments, the obtaining module 512 may be configured to obtain historical data comprising a plurality of features of different system configurations, a plurality of resource consumptions of the different system configurations, and a plurality of rewards respectively generated from the different system configurations. The first training module 514 may be configured to train a plurality of neural network (NN)-based encoders respectively corresponding to the different system configurations based on the plurality of features and the plurality of rewards. The encoding module 516 may be configured to encode, using the plurality of trained NN-based encoders, the plurality of features in the historical data to obtain a plurality of encoded features of the different system configurations. The second training module 518 may be configured to train a multi-armed bandit (MAB) model based on the plurality of encoded features of the different system configurations, the plurality of resource consumptions in the historical data, and the plurality of rewards. The generating module 520 may be configured to generate, using the trained MAB model, a matrix of predicted rewards, each of the predicted rewards corresponding to an estimated reward generated by allocating an amount of resources to one of the different system configurations.

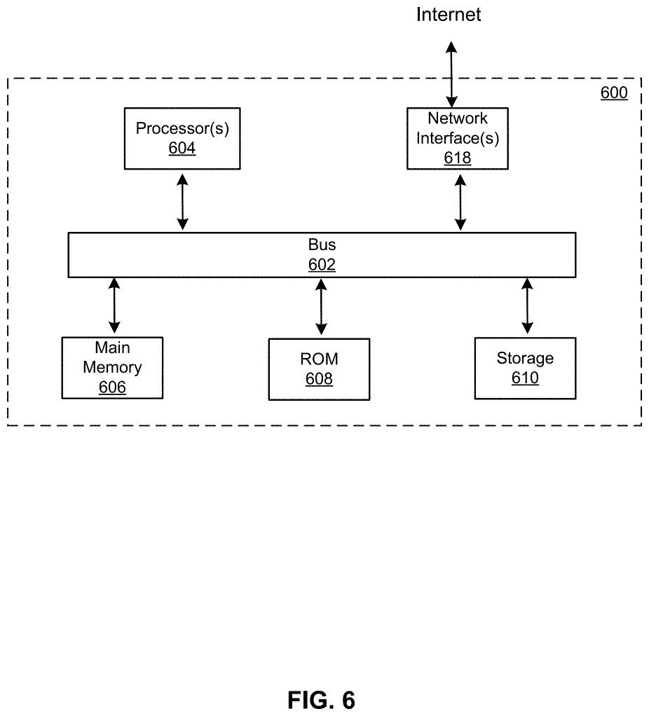

FIG. 6 is a block diagram that illustrates a computer system 600 upon which any of the embodiments described herein may be implemented. The system 600 may correspond to the system 190 or the computing device 109, 110, or 111 described above. The computer system 600 includes a bus 602 or another communication mechanism for communicating information, one or more hardware processors 604 coupled with bus 602 for processing information. Hardware processor(s) 604 may be, for example, one or more general-purpose microprocessors.

The computer system 600 also includes a main memory 606, such as a random access memory (RAM), cache, and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions. The computer system 600 further includes a read-only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may implement the techniques described herein using customized hard-wired logic, one or more ASICs or FPGAs, firmware, and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The main memory 606, the ROM 608, and/or the storage 610 may include non-transitory storage media. The term “non-transitory media,” and similar terms, as used herein refers to a media that store data and/or instructions that cause a machine to operate in a specific fashion. The media excludes transitory signals. Such non-transitory media may include non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge, and networked versions of the same.

The computer system 600 also includes a network interface 618 coupled to bus 602. Network interface 618 provides a two-way data communication coupling to one or more network links that are connected to one or more local networks. For example, network interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic, or optical signals that carry digital data streams representing various types of information.

The computer system 600 can send messages and receive data, including program code, through the network(s), network link, and network interface 618. In the Internet example, a server might transmit a requested code for an application program through the Internet, the ISP, the local network, and the network interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code modules executed by one or more computer systems or computer processors including computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The exemplary blocks or states may be performed in serial, in parallel, or in some other manner. Blocks or states may be added to or removed from the disclosed exemplary embodiments. The exemplary systems and components described herein may be configured differently than described. For example, elements may be added to, removed from, or rearranged compared to the disclosed exemplary embodiments.

The various operations of exemplary methods described herein may be performed, at least partially, by an algorithm. The algorithm may be included in program codes or instructions stored in a memory (e.g., a non-transitory computer-readable storage medium described above). Such algorithm may include a machine learning algorithm. In some embodiments, a machine learning algorithm may not explicitly program computers to perform a function, but can learn from training data to make a predictions model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS).

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the exemplary configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although an overview of the subject matter has been described with reference to specific exemplary embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A computer-implemented method for resource allocation, comprising:
obtaining, by a computing device, historical data comprising a plurality of features of different system configurations, a plurality of resource consumptions of the different system configurations, and a plurality of rewards respectively generated from the different system configurations;
training, by the computing device, a plurality of neural network (NN)-based encoders respectively corresponding to the different system configurations based on the plurality of features and the plurality of rewards;
encoding, by the computing device using the plurality of trained NN-based encoders, the plurality of features in the historical data to obtain a plurality of encoded features of the different system configurations;
training, by the computing device, a multi-armed bandit (MAB) model based on the plurality of encoded features of the different system configurations, the plurality of resource consumptions in the historical data, and the plurality of rewards; and
generating, by the computing device using the trained MAB model, a matrix of predicted rewards, each of the predicted rewards corresponding to an estimated reward generated by allocating an amount of resources to one of the different system configurations.

2. The method of claim 1, further comprising:
receiving, by the computing device, a resource constraint;
constructing, by the computing device, an optimization model based on the matrix of predicted rewards, the optimization model configured to maximize a total reward subject at least to the resource constraint; and
determining, by the computing device based on the optimization model, an optimal resource allocation among the different system configurations.

3. The method of claim 2, wherein:
the optimization model comprises an objective that is subjected to one or more constraints;
the objective comprises a product of the matrix of the predicted rewards and a decision variable matrix, and
determining the optimal resource allocation comprises: determining values of the decision variable matrix that maximize the objective.

4. The method of claim 1, wherein each data entry in the historical data comprises a plurality of features of one system configuration, a resource consumption of the one system configuration, and a reward generated by the one system configuration, and training the plurality of NN-based encoders comprises:
for the one system configuration, constructing a deep neural network (DNN) that comprises an encoder and a decoder;
representing the plurality of features of the one system configuration as a context vector;
feeding the context vector into the encoder to obtain an encoded context vector;
feeding the encoded context vector into the decoder to obtain a decoded context vector;
determining a loss based on the decoded context vector and a supervision extracted from the each data record; and
updating one or more parameters of the DNN based on the loss.

5. The method of claim 4, wherein the supervision extracted from the each data record comprises the context vector, and the loss is determined based on a distance between the decoded context vector and the context vector.

6. The method of claim 4, wherein:
the supervision extracted from the each data record comprises the reward generated by the one system configuration;
the decoded context vector comprises an estimated reward, and
the loss is determined based on a distance between the historical reward and the estimated reward.

7. The method of claim 1, wherein the MAB model comprises a multi-armed system with a plurality of arms respectively corresponding to the different system configurations.

8. The method of claim 7, wherein each data entry in the historical data comprises a plurality of features of one system configuration, a resource consumption of the one system configuration, and a reward generated by the one system configuration, and
training the MAB model comprises:
encoding the plurality of features of the one system configuration using an NN-based encoder corresponding to the one system configuration to obtain a plurality of encoded features of the one system configuration;
representing the plurality of encoded features as an encoded context vector;
concatenating information of the resource consumption of the one system configuration with the encoded context vector to obtain an input;
identifying one of the plurality of arms corresponding to the one system configuration;
feeding the input into the identified arm to obtain an estimated reward; and
updating one or more parameters of the identified arm based on the estimated reward and the reward generated by the one system configuration.

9. The method of claim 1, wherein the MAB model comprises a plurality of multi-armed bandit systems respectively corresponding to the different system configurations, and each of the plurality of multi-armed bandit systems comprises a plurality of arms respectively corresponding to a plurality of resource allocation ranges.

10. The method of claim 9, wherein each data entry in the historical data comprises a plurality of features of one system configuration, a resource consumption of the one system configuration, and a reward generated by the one system configuration, and
training the MAB model comprises:
identifying one of the one or more multi-armed bandit systems corresponding to the one system configuration;
identifying, from the one or more arms of the identified multi-armed bandit system, one arm that corresponds to a resource allocation range covering the resource consumption of the one system configuration;
encoding the plurality of features of the one system configuration using an NN-based encoder corresponding to the one system configuration to obtain a plurality of encoded features of the one system configuration;
representing the plurality of encoded features as an encoded context vector;
feeding the encoded context vector to the identified arm of the identified multi-armed bandit system to obtain an estimated reward; and
updating one or more parameters of the identified arm of the identified multi-armed bandit system based on the estimated reward and the reward generated by the one system configuration.

11. The method of claim 1, wherein a first dimension of the value matrix corresponds to the different system configurations, and a second dimension of the value matrix corresponds to a plurality of resource allocation ranges, wherein each of the plurality resource consumptions in the historical data falls in one of the plurality of resource allocation ranges.

12. One or more non-transitory computer-readable storage media storing instructions executable by one or more processors, wherein execution of the instructions causes the one or more processors to perform operations comprising:
obtaining historical data comprising a plurality of features of different system configurations, a plurality of resource consumptions of the different system configurations, and a plurality of rewards respectively generated from the different system configurations;
training a plurality of neural network (NN)-based encoders respectively corresponding to the different system configurations based on the plurality of features and the plurality of rewards;
encoding, using the plurality of trained NN-based encoders, the plurality of features in the historical data to obtain a plurality of encoded features of the different system configurations;
training a multi-armed bandit (MAB) model based on the plurality of encoded features of the different system configurations, the plurality of resource consumptions in the historical data, and the plurality of rewards; and
generating, using the trained MAB model, a matrix of predicted rewards, each of the predicted rewards corresponding to an estimated reward generated by allocating an amount of resources to one of the different system configurations.

13. The storage media of claim 12, wherein the operations further comprise:
receiving a resource constraint;
constructing an optimization model based on the matrix of predicted rewards, the optimization model configured to maximize a total reward subject at least to the resource constraint; and
determining, based on the optimization model, an optimal resource allocation among the different system configurations.

14. The storage media of claim 13, wherein:
the optimization model comprises an objective that is subjected to one or more constraints;
the objective comprises a product of the matrix of the predicted rewards and a decision variable matrix, and
determining the optimal resource allocation comprises: determining values of the decision variable matrix that maximize the objective.

15. The storage media of claim 12, wherein each data entry in the historical data comprises a plurality of features of one system configuration, a resource consumption of the one system configuration, and a reward generated by the one system configuration, and
training the plurality of NN-based encoders comprises:
for the one system configuration, constructing a deep neural network (DNN) that comprises an encoder and a decoder;
representing the plurality of features of the one system configuration as a context vector;
feeding the context vector into the encoder to obtain an encoded context vector;
feeding the encoded context vector into the decoder to obtain a decoded context vector;
determining a loss based on the decoded context vector and a supervision extracted from the each data record; and
updating one or more parameters of the DNN based on the loss.

16. The storage media of claim 12, wherein the MAB model comprises a plurality of multi-armed bandit systems respectively corresponding to the different system configurations, and each of the plurality of multi-armed bandit systems comprises a plurality of arms respectively corresponding to a plurality of resource allocation ranges.

17. A system comprising one or more processors and one or more non-transitory computer-readable memories coupled to the one or more processors and configured with instructions executable by the one or more processors to cause the system to perform operations comprising:
obtaining historical data comprising a plurality of features of different system configurations, a plurality of resource consumptions of the different system configurations, and a plurality of rewards respectively generated from the different system configurations;
training a plurality of neural network (NN)-based encoders respectively corresponding to the different system configurations based on the plurality of features and the plurality of rewards;
encoding, using the plurality of trained NN-based encoders, the plurality of features in the historical data to obtain a plurality of encoded features of the different system configurations;
training a multi-armed bandit (MAB) model based on the plurality of encoded features of the different system configurations, the plurality of resource consumptions in the historical data, and the plurality of rewards; and
generating, using the trained MAB model, a matrix of predicted rewards, each of the predicted rewards corresponding to an estimated reward generated by allocating an amount of resources to one of the different system configurations.

18. The system of claim 17, wherein the operations further comprise:
receiving a resource constraint;
constructing an optimization model based on the matrix of predicted rewards, the optimization model configured to maximize a total reward subject at least to the resource constraint; and
determining, based on the optimization model, an optimal resource allocation among the different system configurations.

19. The system of claim 17, wherein each data entry in the historical data comprises a plurality of features of one system configuration, a resource consumption of the one system configuration, and a reward generated by the one system configuration, and
training the plurality of NN-based encoders comprises:
for the one system configuration, constructing a deep neural network (DNN) that comprises an encoder and a decoder;
representing the plurality of features of the one system configuration as a context vector;
feeding the context vector into the encoder to obtain an encoded context vector;
feeding the encoded context vector into the decoder to obtain a decoded context vector;
determining a loss based on the decoded context vector and a supervision extracted from the each data record; and
updating one or more parameters of the DNN based on the loss.

20. The system of claim 17, wherein the MAB model comprises a plurality of multi-armed bandit systems respectively corresponding to the different system configurations, and each of the plurality of multi-armed bandit systems comprises a plurality of arms respectively corresponding to a plurality of resource allocation ranges.
